(19) United States
(12) Patent Application Publication
(10) Pub. No.: US 2026/0159420 A1
(43) Pub. Date: Jun. 11, 2026

(54) OPTIMIZATION METHOD AND DEVICE BASED ON INTEGRATION OF FLOCCULATION, VACUUM AND SOLIDIFIED SLUDGE

(71) Applicants: Huzhou Vocational & Technical College, Huzhou (CN); Wuhan University, Wuhan (CN)

(72) Inventors: Dongxing WANG, Wuhan (CN); Xueyong XU, Huzhou (CN); Hongwen CAO, Wuhan (CN); Shengjie DI, Wuhan (CN); Jianhua LI, Huzhou (CN); Chao LI, Huzhou (CN)

(73) Assignees: Huzhou Vocational & Technical College, Huzhou (CN); Wuhan University, Wuhan (CN)

(21) Appl. No.: 18/976,394

(22) Filed: Dec. 11, 2024

(30) Foreign Application Priority Data
Dec. 20, 2023 (CN) 202311763995.2

(51) Int. Cl. C02F 1/00; B01F 27/192; B01F 27/2122; B01F 27/2123; B01F 27/2124; B01F 27/60; B01F 27/70; B01F 35/32; B01F 101/00; C02F 11/00; C02F 11/06; C02F 11/147; C02F 103/00

(52) U.S. Cl. CPC C02F 1/008; B01F 27/192; B01F 27/2122; B01F 27/2123; B01F 27/2124; B01F 27/621; B01F 27/70; B01F 35/3204; C02F 11/008; C02F 11/06; C02F 11/147; B01F 2101/305; C02F 2103/007

(57) ABSTRACT

An optimization method based on integration of flocculation, vacuum, and solidified sludge includes: arranging a sludge treatment device, where the sludge treatment device includes a flocculation conditioning component, an oxidation conditioning component, a solidification conditioning component, a retardation conditioning component, an upper vacuum component, a lower vacuum component, a standing component, and a standing vacuum component, and the upper vacuum component, the lower vacuum component, or the standing vacuum component is evacuated through a vacuum pressure module; dividing the sludge into high organic matter sludge, small batch of low organic matter sludge, and large batch of low organic matter sludge for treatment according to a sludge quality and organic matter content of sludge; and selecting the appropriate component top-down grading splicing according to the processing object. In each sludge treatment process, work is completed in one component before proceeding to the next component until the treatment is completed.

### CROSS REFERENCE TO THE RELATED APPLICATIONS

This application is based upon and claims priority to Chinese Patent Application No. 202311763995.2, filed on Dec. 20, 2023, the entire contents of which are incorporated herein by reference.

### TECHNICAL FIELD

The present invention relates to the field of sludge disposal technology, in particular to an optimization method and device based on an integration of flocculation, vacuum and solidification sludge.

### BACKGROUND

A large amount of dredged sludge with high moisture content will be produced in engineering construction and river dredging, the dredged sludge was usually treated by natural sedimentation through the establishment of the yard in the past, and the sludge utilization rate was low. There are many existing methods for treating dredged sludge, including but not limited to surcharge preloading, vacuum preloading, flocculation, electroosmosis, pressure filtration, solidification, etc. but a single treatment method cannot achieve the desired effect when treat the sludge with different moisture content, particularly when treat the sludge with high moisture content.

In recent years, a new method for treating engineering waste sludge by combining flocculation, vacuum preloading, and solidification has been widely studied, and an integrated device for systematic sludge treatment has been developed. The integrated device refers to the simultaneous addition of sludge and various conditioners and condition the sludge soil at the same time.

However, the sludge produced in different engineering constructions and dredging of different rivers usually has different properties. If various conditioners are added simultaneously at once, not only will not produce good effect on sludge treatment, but also may have reverse effect, additionally, the same integrated device is generally used when treating sludge by the related methods, and the sludge of different properties cannot be efficiently utilized.

### SUMMARY

Based on the shortcomings of the existing technology, an objective of the present invention is to provide an optimization method and device based on an integration of flocculation, vacuum and solidification sludge, which can process different types of sludge, and perform a grading splicing connection by arranging a variety of components, the sludge can enter the next component after completing the work in one component to improve the efficient utilization rate of the sludge.

In order to solve the above technical problem, the technical solution adopted by the present invention is:
an optimization method based on an integration of flocculation, vacuum and solidified sludge, including the following steps:
arranging a sludge treatment device: the device includes a flocculation conditioning component, an oxidation conditioning component, a solidification conditioning component, a retardation conditioning component, an upper vacuum component, a lower vacuum component, a standing component and a standing vacuum component which are respectively added with a flocculant, an oxidant, a solidification agent and a retarder, wherein the upper vacuum component, the lower vacuum component or the standing vacuum component are evacuated through a vacuum pressure module;
determining a treatment object: dividing the sludge into high organic matter sludge, a small batch of low organic matter sludge and a large batch of low organic matter sludge for treatment according to an organic matter content of sludge and sludge quality;
high organic matter sludge treatment: a top-down grading splicing of the flocculation conditioning component, the upper vacuum component, the lower vacuum component, the oxidation conditioning component, the solidification conditioning component and the standing component;
a small batch of low organic matter sludge treatment: the top-down grading splicing of the flocculation conditioning component, the upper vacuum component, the lower vacuum component, the solidification conditioning component and the standing component;
a large batch of low organic matter sludge treatment: the top-down grading splicing of the flocculation conditioning component, the retardation conditioning component, the solidification conditioning component and the standing vacuum component;
In each sludge treatment process, work is completed in one component before proceeding to the next component until the treatment is completed.

Further, in the sludge treatment process, obtaining an optimal dosage of the flocculant, oxidant, solidification agent or retarder by changing a dosage of flocculant, oxidant, solidification agent or retarder to carry out multiple tests;
obtaining an optimal time node of an action of each component by changing a time node of an action of various components to carry out multiple tests;
obtaining a comprehensive treatment effect of the flocculant, oxidant, solidification agent or retarder with different dosages and different time nodes according to multiple tests.

Further, the flocculant adopts anionic polyacrylamide, the retarder adopts sodium pyrophosphate or sodium gluconate, the oxidant adopts potassium ferrate, and the solidification agent adopts cement.

Further, the dosage of various conditioners is selected according to the following ratios: a ratio of a mass of the anionic polyacrylamide, the cement and the potassium ferrate to a mass of dry soil is 0.05%-0.2%, 10%-50% and 0.1%-0.5% respectively, a ratio of the mass of sodium pyrophosphate and sodium gluconate to a mass of cement is 0.1%-0.6% and 0.05%-0.2% respectively.

Further, an organic matter threshold value is arranged, wherein the organic matter threshold value is 4%-6% of the dry soil mass, and if an organic matter content exceeds the organic matter threshold value, it indicates that the sludge is the high organic matter sludge, and if the organic matter content does not exceed the organic matter threshold value, it indicates that the sludge is the low organic matter sludge.

An optimization device based on the integration of flocculation, vacuum and solidified sludge, the device is used for realizing the optimization method based on the integration of flocculation, vacuum and solidified sludge according to any one of the methods, the device includes the following:
a stirring cylinder, wherein a stirrer is arranged inside the stirring cylinder, a material inlet is arranged on a side of the stirring cylinder, and the stirring cylinder is formed into the flocculation conditioning component, the oxidation conditioning component, the solidification conditioning component or the retardation conditioning component by adding the flocculant, oxidant, solidification agent or retarder at the material inlet;
a vacuum cylinder, wherein the upper vacuum component is formed by arranging a first vacuum device in an upper part inside the vacuum cylinder, and the lower vacuum component is formed by arranging the first vacuum device in a lower part inside the vacuum cylinder;
a standing cylinder, wherein the standing component is formed when the standing cylinder is empty, and a second vacuum device is arranged inside the standing cylinder to form the standing vacuum component;
a vacuum pressure module, the vacuum pressure module includes a vacuum pump and a water gas separator connected to the vacuum pump through a first vacuumizing tube, wherein the water gas separator is connected to the first vacuum device or the second vacuum device through a second vacuumizing tube to vacuumize the upper vacuum component, the lower vacuum component or the standing vacuum component;
wherein the stirring cylinder, the vacuum cylinder and the standing cylinder are all made of a transparent material, all the top and the bottom of the stirring cylinder, the vacuum cylinder and the standing cylinder are provided with a connecting member and a sludge conveying interface, the sludge conveying interface is provided with a sealing plate and an opening and closing driving member for driving an opening and closing of the sealing plate, one or more of the flocculation conditioning component, the oxidation conditioning component, the solidification conditioning component, the retardation conditioning component, the upper vacuum component, the lower vacuum component, the standing component and the standing vacuum component are combined according to requirements to form a sludge treatment device for treating sludge, and adjacent components are connected through the connecting member.

Further, the stirrer includes an external driving member and an internal stirring member, the internal stirring member includes a hollow rod and a stirring bracket connected to the hollow rod through a coaxial reverser, the stirring bracket is provided with a plurality of first stirring blades uniformly distributed at a certain distance, the hollow rod is provided with a plurality of second stirring blades uniformly distributed at a certain distance, the first stirring blades and the second stirring blades are alternately arranged in an extension direction of the hollow rod, the hollow rod is provided with a plurality of discharge ports, and the hollow rod is fixed on the material inlet, the external driving member drives the hollow rod to rotate.

Further, the external driving member is fixed on the stirring cylinder, the external driving member includes a drive housing and a drive motor, a drive gear, a ring gear, a planet wheel, a hollow telescopic rod, and a sun wheel are arranged in the drive housing, the drive motor drives the drive gear to rotate, the drive gear meshes with an outer ring of the ring gear, an inner ring of the ring gear meshes with the planet wheel, the hollow telescopic rod is fixed on the planet wheel, the sun wheel meshes with the planet wheel, and a double-acting hydraulic pump is fixed on the sun wheel, an output shaft of the double-acting hydraulic pump is rotatably connected to a rotary member, the rotary member is fixed on the hollow telescopic rod, the drive housing is rotatably connected to a first rotary disk, a material port is arranged on the first rotary disk, one end of the hollow telescopic rod is connected to the material port, the stirring cylinder is rotatably connected to a second rotary disk, the material inlet is arranged on the second rotary disk, and another end of the hollow telescopic rod is connected to the material inlet.

Further, the first vacuum device includes a first horizontal vacuum tube and a spring, wherein the first horizontal vacuum tube is an L-shaped structure, one end of the first horizontal vacuum tube is connected to the second vacuumizing tube, and another end of the first horizontal vacuum tube is provided with a spring interface, a plurality of the springs are all connected to the spring interfaces, an end of the springs is sleeved with a spring cover, an outside of the springs is wrapped with geotextile or a sealing film, and the first horizontal vacuum tube is in communication with the second vacuumizing tube.

Further, the second vacuum device includes a second horizontal vacuum tube and at least one vertical vacuum tube in communication with the second horizontal vacuum tube, the vertical vacuum tube is in communication with a plurality of horizontal drainage plates with a vertical interval at a certain distance distribution, the second horizontal vacuum tube is in communication with the second vacuumizing tube.

Compared with the existing technology, the present invention has the following advantages and beneficial effects:
1. the present invention provides an optimization method and device based on the integration of flocculation, vacuum and solidified sludge, the device is assembled for different treatment objects and treatment targets and targeted optimization methods are adopted, it achieves better results than conventional integrated treatment for engineering waste sludge with low organic matter content, the grading method broadens the application field of flocculation, vacuum and solidified sludge integration without affecting other steps in the case of introducing oxidant conditioning.

2. the present invention provides an optimization method and device based on integration of flocculation, vacuum and solidified sludge, which makes improvements for the whole flocculation, vacuum preloading and solidified sludge integration device, specifically, the stirring method of the stirring link is improved, which effectively ensures the uniformity of the stirring, additionally, the vacuum link can carry out horizontal vacuum and vertical vacuum at the same time, and the horizontal vacuum of the standing link can be carried out smoothly with the sedimentation of the soil.

### BRIEF DESCRIPTION OF THE DRAWINGS

The drawings described herein are used to provide further understanding of the present invention and form part of this application. The indicative embodiment of the present invention and the explanation thereof are used to explain the present invention and do not constitute an improper limitation of the present invention. In the attached drawings:

FIG. 1 is an assembly schematic diagram of a control group of an engineering sludge optimization effect treatment of embodiment 1 and a dredging lake sludge optimization effect treatment of embodiment 2 in the present invention;
FIG. 2 is an assembly schematic diagram of an experimental group for a dredging lake sludge optimization effect treatment of the embodiment 2 in the present invention;
FIG. 3 is an assembly schematic diagram of experimental groups 1 and 2 of a large-scale treatment of engineering sludge in embodiment 3 in the present invention;
FIG. 4 is a front view of the structure of a sludge treatment device in the present invention;
FIG. 5 is a left view of the structure of a stirring cylinder in the present invention;
FIG. 6 is a schematic diagram of an internal structure of an external driving member of a stirring cylinder in the present invention;
FIG. 7 is a structural schematic diagram of a sealing plate and a connecting member of a sludge treatment device in the present invention;
FIG. 8 is a structural schematic diagram of an upper vacuum component in the present invention;
FIG. 9 is a structural schematic diagram of the horizontal anti-filter tube in a vacuum cylinder in the present invention;
FIG. 10 is a connecting schematic diagram of a horizontal drainage plate of a standing vacuum component in the present invention;
FIG. 11 is an assembly schematic diagram of the first control group of the large-scale treatment of engineering sludge in embodiment 3 in the present invention;
FIG. 12 is an assembly schematic diagram of the second control group for mass treatment of engineering sludge in embodiment 3 in the present invention.

Reference numerals in figures: 100, a stirring cylinder; 101, a material inlet; 102, a sludge conveying interface; 103, a connecting member; 104, a second rotary disk; 105, a sealing plate; 1051, a first sealing plate; 1052, a second sealing plate; 106, an opening and closing driving member; 1061, a slide rail; 1062, a first synchronous wheel; 1063, a second synchronous wheel; 1064, a synchronous belt; 1065, a first connecting rod; 1066, a second connecting rod; 110, a flocculation conditioning component; 120, an oxidation conditioning component; 130, a solidification conditioning component; 140, a retardation conditioning component; 150, an external driving member; 151, a drive housing; 152, a drive motor; 153, a drive gear; 154, a ring gear; 155, a planet wheel; 156, a hollow telescopic rod; 157, a sun wheel; 158, a first rotary disk; 159, a material port; 1510, a double-acting hydraulic pump; 1511, a rotary member; 160, an internal stirring member; 161, a hollow rod; 162, a coaxial reverser; 163, a stirring bracket; 164, a first stirring blade; 165, a second stirring blade; 166, a discharge port;
200, a vacuum cylinder; 210, an upper vacuum component; 220, a lower vacuum component; 230, a first vacuum device; 231, a first horizontal vacuum tube; 232, a spring; 233, a spring interface; 234, a spring cover; 235, a sealing ring;
300, a standing cylinder; 310, a standing component; 320, a standing vacuum component; 330, a second vacuum device; 331, a second horizontal vacuum tube; 332, vertical vacuum tube; 333, a bellows interface; 334, a bellows; 335, a handshake fitting; 336, a sealing cover; 337, a horizontal drainage plate;
400, a vacuum pressure module; 401, a vacuum pump; 402, a first vacuumizing tube; 403, a water gas separator; 404, a second vacuumizing tube; 405, a valve; 406, a vacuum gauge.

### DETAILED DESCRIPTION OF THE EMBODIMENTS

The following will combine the specific implementation methods and embodiments to elaborate the present invention, and the advantages and various effects of the present invention will be more clearly presented. Technicians in this field should understand that these specific implementation methods and embodiments are are merely illustrative of the present invention and is not intended to limit the present invention.

Throughout the specifications, unless otherwise specified, the terms used in this article should be understood as the meaning commonly used in this field. Therefore, unless otherwise defined, technical or scientific terms used in the present invention are to be given their ordinary meaning as understood by those of ordinary skill in the art to which the present invention belongs. If there is a contradiction, this specification is preferred.

It should be noted that when the component is ‘fixed’ or ‘arranged on’ another component, it can be directly on another component or indirectly arranged on another component; when a component is ‘connected’ to another component, it can be directly connected to another component or indirectly connected to another component.

In the above description of the present invention, it is to be noted that the orientation or positional relationship indicated by terms ‘length’, ‘width’, ‘up’, ‘down’, ‘front’, ‘back’, ‘vertical’, ‘horizontal’, ‘top’, ‘bottom’, ‘inside’, ‘outside’, etc. is based on the orientation or positional relationship shown in the accompanying drawings, merely for ease of description and simplification of the description of the present invention, and not to indicate or imply that the referenced device or element must have a particular orientation and be constructed and operative in a particular orientation, and thus may not be construed as a limitation on the present invention.

In addition, in the description of this application, ‘a plurality of’, ‘several’ means two or more, unless otherwise specified.

An optimization method and device based on integration of flocculation, vacuum and solidified sludge will be described in detail below in conjunction with the accompanying drawings.

An optimization method based on an integration of flocculation, vacuum and solidified sludge, including the following steps:
a sludge treatment device is arranged: the device includes a flocculation conditioning component 110, an oxidation conditioning component 120, a solidification conditioning component 130, a retardation conditioning component 140, an upper vacuum component 210, a lower vacuum component 220, a standing component 310 and a standing vacuum component 320 which are respectively added with a flocculant, an oxidant, a solidification agent and a retarder, wherein the upper vacuum component 210, the lower vacuum component 220 or the standing vacuum component 320 are evacuated through a vacuum pressure module 400;
a treatment object is determined: the sludge is divided into high organic matter sludge, a small batch of low organic matter sludge and a large batch of low organic matter sludge for treatment according to an organic matter content of sludge and sludge quality; wherein, the treatment object includes high organic matter sludge which represented by dredged sludge, and low organic matter sludge which represented by engineering waste sludge; the treatment target includes the effect optimization treatment and large batch treatment, and large batch of low organic matter sludge treatment is used to simulate the foundation pit backfilling of engineering sludge;
high organic matter sludge treatment, as shown in FIG. 1, a top-down grading splicing of the flocculation conditioning component 110, the upper vacuum component 210, the lower vacuum component 220, the oxidation conditioning component 120, the solidification conditioning component 130 and the standing component 310;
a small batch of low organic matter sludge treatment, as shown in FIG. 2, the top-down grading splicing of the flocculation conditioning component 110, the upper vacuum component 210, the lower vacuum component 220, the solidification conditioning component 130 and the standing component 310;
a large batch of low organic matter sludge treatment, as shown in FIG. 3, the top-down grading splicing of the flocculation conditioning component 110, the retardation conditioning component 140, the solidification conditioning component 130 and the standing vacuum component 320;

In each sludge treatment process, work is completed in one component before proceeding to the next component until the treatment is completed.

Wherein, the most important effect of the flocculant is to accelerate the self-weight sedimentation of the soil, followed by the flocs formed by the flocculant can slow down the clogging effect in the vacuum stage and the complex formed by the flocculant can have a weak effect on the strength; the effect of the retarder is to delay the hydration process of the solidification agent, so that the hydration will not interfere with the flocculation and vacuum preloading process prematurely; the effect of the oxidant is to remove the organic matter in the sludge by oxidation, but the strong oxidant will unchain the organic flocculant with better flocculation effect and produce negative effects, the effect of the solidification agent is to perform a hydration reaction in the sludge and improve the strength of the soil.

The present invention provides a preferred sludge treatment method based on the properties of sludge, and provides an integrated device for sludge treatment: the integrated device for sludge treatment includes a sludge conditioning module, a standing component 310 and a vacuum pressure module 400, the sludge conditioning module includes a flocculation conditioning component 110, an oxidation conditioning component 120, a solidification conditioning component 130, an upper vacuum component 210, a lower vacuum component 220 which are respectively added with a flocculant, an oxidant, and a solidification agent, which can process different types of sludge, and perform a grading splicing connection by arranging a variety of components, the sludge can enter the next component after completing the work in one component to improve the efficient utilization rate of the sludge.

In the present invention, in engineering sludge treatment or dredging lake sludge treatment, an optimal dosage of the flocculant, oxidant, or solidification agent is obtained by changing a dosage of flocculant, oxidant, or solidification agent to carry out multiple tests;
an optimal time node of an action of each conditioning component is obtained by changing a time node of an action of various conditioning components to carry out multiple tests;
a comprehensive treatment effect of the flocculant, oxidant, or solidification agent with different dosages and different time nodes is obtained according to multiple tests.

In the present invention, the flocculant is adopted anionic polyacrylamide (APAM), the oxidant is adopted potassium ferrate, the retarder is adopted sodium pyrophosphate or sodium gluconate, and the solidification agent is adopted cement. Considering the flocculation efficiency and economic cost, the molecular weight of anionic polyacrylamide can be selected from 12 million to 16 million, anionic polyacrylamide needs to be prepared in advance according to the mass ratio of anionic polyacrylamide particles to water of 1:1000 and stirred at 60-90r/min for 40-45 min to prepare an anionic polyacrylamide solution with a concentration of 0.1%, cement can use the most common commercially available P·O42.5 cement; potassium ferrate can be used the common commercially analysis of pure purity products; the concentration of sodium pyrophosphate solution can be 5%.

In the present invention, the dosage of various conditioners is selected according to the following ratios: a ratio of a mass of the anionic polyacrylamide, the cement and the potassium ferrate to a mass of dry soil is 0.05%-0.2%, 10%-50% and 0.1%-0.5% respectively, a ratio of the mass of sodium pyrophosphate and sodium gluconate to a mass of cement is 0.1%-0.6% and 0.05%-0.2% respectively.

In the specific embodiment of the present invention, the dosage of conditioner in the experimental group and the control group is 0.1% anionic polyacrylamide, 20% cement, 0.4% potassium ferrate, 0.3% sodium pyrophosphate, and 0.1% sodium gluconate, and the moisture content of the soil is uniformly adjusted to 500%.

In the present invention, when a large batch of engineering sludge is treated, a retardation conditioning component 140 is arranged above the flocculation conditioning component 110.

In the present invention, an organic matter threshold value is arranged, wherein the organic matter threshold value is 4%-6% of the dry soil mass, and if an organic matter content exceeds the organic matter threshold value, it indicates that the sludge is the high organic matter sludge, and if the organic matter content does not exceed the organic matter threshold value, it indicates that the sludge is the low organic matter sludge.

With reference to FIGS. 1-12, an optimization device based on the integration of flocculation, vacuum and solidified sludge is provided in the present invention, the device is used for realizing the optimization method based on the integration of flocculation, vacuum and solidified sludge, the device includes a stirring cylinder 100, a vacuum cylinder 200, a standing cylinder 300, and a vacuum pressure module 400.

A stirrer is arranged inside the stirring cylinder 100, a material inlet 101 is arranged on a side of the stirring cylinder 100, and the stirring cylinder 100 is formed into the flocculation conditioning component 110, the oxidation conditioning component 120, the solidification conditioning component 130 or the retardation conditioning component 140 by adding the flocculant, oxidant, solidification agent or retarder at the material inlet 101.

The vacuum cylinder 200 forms the upper vacuum component 210 by arranging a first vacuum device 230 in the middle and upper part of the inner side of the vacuum cylinder 200, and the lower vacuum component 220 is formed by arranging the first vacuum device 230 in the middle and lower part of the inner side of the vacuum cylinder 200;

The standing vacuum component 310 is formed by the standing cylinder 300;
The vacuum pressure module 400 includes a vacuum pump 401 and a water gas separator 403 connected to the vacuum pump 401 through a first vacuumizing tube 402, wherein the water gas separator 403 is connected to the first vacuum device 230 through a second vacuumizing tube 404 to vacuumize the upper vacuum component 210, or the lower vacuum component 220.

Wherein the stirring cylinder 100, the vacuum cylinder 200 and the standing cylinder 300 are all made of a transparent material, all the top and the bottom of the stirring cylinder 100, the vacuum cylinder 200 and the standing cylinder 300 are provided with a connecting member 103 and a sludge conveying interface 102, the sludge conveying interface 102 is provided with a sealing plate 105 and an opening and closing driving member 106 for driving an opening and closing of the sealing plate 105.

In the present invention, one or more of the flocculation conditioning component 110, the oxidation conditioning component 120, the solidification conditioning component 130, the retardation conditioning component 140, the upper vacuum component 210, the lower vacuum component 220, and the standing component 310 are combined according to requirements to form a sludge treatment device for treating sludge, and adjacent components are connected through the connecting member 103, and each processing step can be componentized and graded in the treatment of sludge, compared with the previous integrated treatment, better treatment effect can be obtained.

Compared with the existing technology, the flocculation conditioning component 110, the oxidation conditioning component 120, the solidification conditioning component 130, the retardation conditioning component 140, the upper vacuum component 210, the lower vacuum component 220, and the standing component 310 are all unified components, during the mounting process of the optimization device, the mounting can be completed by simply stacking up and down and connecting through the connecting member 103, so that the optimization device is more systematic in production and assembly, and it is convenient for installers to quickly understand and get start.

Below is a detailed description of the stirring cylinder 100, with reference to FIGS. 4-6.

In the present invention, the stirring cylinder 100 is made of transparent glass, and a stirrer is arranged in the transparent glass.

In the present invention, the stirrer includes an external driving member 150 and an internal stirring member 160.

The internal stirring member 160 includes a hollow rod 161 and a stirring bracket 163 connected to the hollow rod 161 through a coaxial reverser 162, the stirring bracket 163 is provided with a plurality of first stirring blades 164 uniformly distributed at a certain distance, the hollow rod 161 is provided with a plurality of second stirring blades 165 uniformly distributed at a certain distance, the first stirring blades 164 and the second stirring blades 165 are alternately arranged in an extension direction of the hollow rod 161, the hollow rod 161 is provided with a plurality of discharge ports 166, and the hollow rod 161 is fixed on the material inlet 101, the external driving member 150 drives the hollow rod 161 to rotate.

In the process of use, the hollow rod 161 is driven by the external driving member 150 to rotate, so that the hollow rod 161 and the stirring bracket 163 rotate in the opposite direction, so that the first stirring blade 164 and the second stirring blade 165 rotate in the opposite direction, and the sludge and materials are stirred, wherein the materials are flocculant, solidification agent or retarder.

Specifically, the stirring bracket 163 is a rectangle-shaped structure, and the first stirring blade 164 is arranged on the upper and lower sides of the stirring bracket 163.

The external driving member 150 is fixed on the stirring cylinder 100, the external driving member 150 includes a drive housing 151 and a drive motor 152, a drive gear 153, a ring gear 154, a planet wheel 155, a hollow telescopic rod 156, and a sun wheel 157 are arranged in the drive housing 151, the drive motor 152 is arranged in the drive housing 151 and the drive gear 153 is connected to the output shaft of the drive motor 152, and the drive motor 152 drives the drive gear 153 to rotate, the ring gear 154 is rotatably connected to the inside of the drive housing 151, the drive gear 153 meshes with an outer ring of the ring gear 154, an inner ring of the ring gear 154 meshes with the planet wheel 155, the hollow telescopic rod 156 is fixed on the planet wheel 155, the sun wheel 157 is rotatably connected to the inside of the drive housing 151 and meshes with the planet wheel 155, and a double-acting hydraulic pump 1510 is fixed on the sun wheel 157, an output shaft of the double-acting hydraulic pump 1510 is rotatably connected to a rotary member 1511, the double-acting hydraulic pump 1510 through a hydraulic directional valve and an oil tank to achieve lateral reciprocating motion, the rotary member 1511 is fixed on the hollow telescopic rod 156, the drive housing 151 is rotatably connected to a first rotary disk 158, a material port 159 is arranged on the first rotary disk 158, one end of the hollow telescopic rod 156 is connected to the material port 159, the stirring cylinder 100 is rotatably connected to a second rotary disk 104, the material inlet 101 is arranged on the second rotary disk 104, and another end of the hollow telescopic rod 156 is connected to the hollow rod 161 through the material inlet 101.

In the process of use, the material enters into the hollow telescopic rod 156 through the material port 159, then enters into the hollow rod 161 through the material inlet 101 from the hollow telescopic rod 156, and combines with the sludge from the discharge port 166 to the stirring cylinder 100;
the drive motor 152 drives the drive gear 153 to rotate, the drive gear 153 drives the ring gear 154 to rotate, and the ring gear 154 drives the planet wheel 155 to rotate, because the planet wheel 155 is fixed with a hollow telescopic rod 156, and the stirring cylinder 100 is rotatably connected to a second rotary disk 104, the material inlet 101 is arranged on the second rotary disk 104, and the other end of the hollow telescopic rod 156 is connected to the hollow rod 161 through the material inlet 101. Therefore, the hollow telescopic rod 156 will drive the hollow rod 161 to rotate relative to the sun wheel 157 within the stirring cylinder 100, increasing the stirring effect;
the planet wheel 155 drives the sun wheel 157 to rotate, because the double-acting hydraulic pump 1510 is fixed on the sun wheel 157, the output shaft of the double-acting hydraulic pump 1510 is rotatably connected to a rotary member 1511, the rotary member 1511 is fixed on the hollow telescopic rod 156, therefore, the hollow telescopic rod 156 will stretch back and forth with respect to the stirring cylinder 100, so that the hollow rod 161 will expand and contract back and forth within the stirring cylinder 100, further increasing the stirring effect.

That is, in the stirring cylinder 100, the material comes out from the discharge port 166 of the hollow rod 161, moves in the opposite direction through the first stirring blade 164 and the second stirring blade 165, and stretches back and forth in the stirring cylinder 100, and rotates relative to the sun wheel 157 in the stirring cylinder 100, so that the material and sludge are fully mixed evenly. Compared with the existing technology, it can effectively ensure the uniformity of stirring.

In order to make the first rotary disk 158 and the second rotary disk 104 rotate, an annular slide groove is arranged on the side wall of the stirring cylinder 100 and the drive housing 151, the first rotary disk 158 and the second rotary disk 104 are respectively arranged in the annular slide groove on the side wall of the stirring cylinder 100 and the drive housing 151, the outer side of the first rotary disk 158 and the second rotary disk 104 is sleeved with a sealing ring 235, and the material inlet 101 and the material port 159 are also provided with the sealing ring 235.

Below is a detailed description of the first vacuum device 230, with reference to FIGS. 8-9.

The first vacuum device 230 includes a first horizontal vacuum tube 231 and a spring 232, wherein the first horizontal vacuum tube 231 is an L-shaped structure, one end of the first horizontal vacuum tube is connected to the second vacuumizing tube 404, and another end of the first horizontal vacuum tube is provided with a spring interface 233, a plurality of the springs 232 are all connected to the spring interfaces 233, an end of the springs 232 is sleeved with a spring cover 234, an outside of the springs 232 is wrapped with geotextile or a sealing film, the function of the spring cover 234 is to ensure that the vacuum negative pressure will not be lost from the axial direction of the spring 232, and ensure that it all acts on the side wall surface of the spring 232; when the spring 232 is connected to the spring interface 233 and the spring cover 234, the connection is sealed with the sealing ring 235, and the first horizontal vacuum tube 231 is in communication with the second vacuumizing tube 404.

The first horizontal vacuum tube 231 is evacuated by the vacuum pressure module 400.

The upper vacuum component 210 is formed by arranging the first vacuum device 230 in the middle and upper part of the inner side of the vacuum cylinder 200, and the lower vacuum component 220 is formed by arranging the first vacuum device 230 in the middle and lower part of the inner side of the vacuum cylinder.

When the wall of the spring 232 is wrapped with a cycle of geotextile, the spring 232 is used as the frame, and the geotextile plays the role of the filter layer, the spring 232 and the geotextile form an anti-filter tube jointly; if the wall of the spring 232 is wrapped with a cycle of sealing film, the vacuum negative pressure cannot be transmitted from the spring 232.

In the specific embodiment of the present invention, the spring interface 233 has five interfaces, which enables the spring interface 233 to connect five springs 232, specifically, the spring interface 233 has a downward interface and four interfaces with a cross-shaped distribution in the horizontal direction, the downward interface connects the spring 232 wrapped in the geotextile to form a vertical anti-filter tube, and the four interfaces with a cross-shaped distribution connect the spring 232 wrapped in the geotextile or the sealing film to form a horizontal anti-filter tube; the vertical anti-filter tube is wrapped by geotextile in the upper vacuum component 210, and the horizontal anti-filter tube is wrapped by sealing film, the vertical anti-filter tube and horizontal anti-filter tube are wrapped by geotextile in the lower vacuum component 220.

The upper vacuum component 210 can only transfer the vacuum degree in the vertical anti-filter tube by wrapping the horizontal anti-filter tube with a sealing film instead of geotextile, which improves the efficiency of the upper vacuum component 210 to extract the supernatant.

Four horizontal anti-filter tubes with a cross-shaped distribution in the horizontal direction are arranged on the spring interface 233 of the lower vacuum component 220, which can spread the vacuum degree more evenly, reduce the uneven lateral deformation of the sludge soil, and improve the integrity of the sludge soil after treatment.

Specifically, the advantage of the anti-filter tube formed by using spring 232 with geotextile is that the spring 232 has a certain stiffness, when the upper sludge soil enters the vacuum device, the anti-filter tube will not be destroyed due to the fall of the soil.

As a specific implementation method, when selecting the spring 232 in the vertical anti-filter tube in the upper vacuum component 210, the length of the spring 232 needs to be selected according to the predicted height of the soil after the upper vacuum component 210 is processed to ensure that the spring 232 can finally maintain contact with the soil without entering the soil; the role of the vertical anti-filter tube in the upper vacuum component 210 is to discharge the supernatant in the upper vacuum component 210 but not to spread the vacuum degree in the soil, that is, the soil does not produce excess pore water pressure.

Compared with the existing technology, the upper vacuum component 210 can freely settle with the sedimentation of the soil when it is in the upper vacuum, and can pump the supernatant without transferring the vacuum negative pressure to the soil; the lower vacuum component 220 can realize horizontal and vertical vacuum preloading at the same time when it is in the lower vacuum, so that the vacuum degree can spread more evenly in the soil and reduce the uneven sedimentation of the soil, the spring 232 in the vertical anti-filter tube of the lower vacuum component 220 can also be selected according to the initial soil height entering the lower vacuum component 220, and the soil itself is used for sealing to further reduce the loss of vacuum degree at the beginning.

Below is a detailed description of the standing vacuum component 320, with reference to FIG. 3, and FIG. 10.

The second vacuum device 330 includes a second horizontal vacuum tube 331 and at least one vertical vacuum tube 332 in communication with the second horizontal vacuum tube 331, the vertical vacuum tube 332 is in communication with a plurality of horizontal drainage plates 337 with a vertical interval at a certain distance distribution, the second horizontal vacuum tube 331 is in communication with the second vacuumizing tube 404.

Specifically, the second vacuum device 330 further includes a bellows interface 333, a bellows 334, geotextile, the sealing ring 235, a handshake fitting 335 and a sealing cover 336, the bellows interface 333 is welded on the vertical vacuum tube 332, the vacuum negative pressure can be directly transferred from the vertical vacuum tube 332 to the bellows interface 333, one end of the bellows 334 is connected to the bellows interface 333, and one end is connected to the handshake fitting 335, both ends of the bellows 334 are sealed with sealing rings 235; the horizontal drainage plate 337 is connected by inserting the handshake fitting 335, and the geotextile wraps the upper and lower sides of the horizontal drainage plate 337, the sealing cover 336 covers the top side of the sludge soil in the standing vacuum component 320, and the sludge all falls into the standing vacuum component 320 to cover the sealing cover 336 to prevent the loss of vacuum negative pressure.

In the process of vacuum preloading of the standing vacuum component 320, due to the continuous sedimentation of the soil, it will inevitably lead to the sedimentation of the horizontal drainage plate 337, so that the bellows interface 333 and the horizontal drainage plate 337 cannot be kept on the same horizontal plane; if it is not controlled or solved, it will inevitably lead to the inclination or bending of the horizontal drainage plate 337; when the soil settles, the bellows 334 deforms and moves down, so that the horizontal drainage plate 337 settles with the sedimentation of the soil, reducing the possibility of the horizontal drainage plate 337 tilting or bending, thus ensuring the drainage efficiency of the standing device.

In the present invention, one end of the handshake fitting 335 is cylindrical and connected to the bellows 334, and one end of the handshake fitting 335 is a conventional handshake fitting drainage plate connection shape, which is fixed with rivets.

In the present invention, the horizontal vacuum tube is in communication with a plurality of vertical vacuum tubes 332, and the horizontal drainage plate 337 on a plurality of vertical vacuum tubes 332 is arranged alternately up and down. The alternating arrangement can make the vacuum degree more evenly spread; the biggest reason for the clogging effect of the drainage plate is that small particles block the drainage aperture, when the vertical vacuum tube 332 is provided with a valve 405, the small particles can also move up and down by opening the valve 405 alternately, which effectively prevents the drainage plate from delaying the clogging phenomenon.

In the present invention, both geotextile and horizontal drainage plate 337 have an anti-filtration effect, and the simultaneous use of the two can increase the drainage efficiency.

Compared with the existing technology, the innovation point of the standing vacuum component 320 is that the horizontal drainage plate 337 can be settled with the sedimentation of the soil, and the alternating arrangement of the horizontal drainage plate 337 can also effectively delay the clogging of the drainage plate; the indoor test seal was sealed with a plastic bag in the past, which was not convenient to observe the test phenomenon and the sealing could not be guaranteed, the standing module of the device used a sealing cover 336 made of glass for vacuum sealing, which could not only facilitate the observation of the test phenomenon but also ensure the sealing.

Below is a detailed description of the vacuum pressure module 400, with reference to FIGS. 1-3, and FIG. 11.

The vacuum pressure module 400 includes a water gas separator 403, a valve 405, a vacuum gauge 406 and a vacuum pump 401. The vacuum pressure module 400 is connected to the first vacuum device 230 through the vacuumizing tube, and connected to the standing vacuum component 320 through the second vacuumizing tube 404. The water discharged by the upper vacuum component 210, the lower vacuum component 220 and the standing vacuum component 320 is stored in their respective water gas separator 403, the water gas separator 403 is marked with a scale to observe the drainage volume; the vacuum gauge 406 observes the size of the vacuum negative pressure; the vacuum pump 401 is a vacuum negative pressure source.

In the present invention, each pipe is connected through the bite between the threads, and the connecting member 103 of the adjacent two components is connected by bolts.

In the present invention, the input flow of various conditioners and sludge and the spread of vacuum negative pressure is controlled by valve 405.

In the present invention, when assembling the sludge treatment device, several components required for this time are selected, and several components are stacked on the same vertical surface and connected to each other by bolts, the upper vacuum component 210, the lower vacuum component 220 or the standing vacuum component 320 are connected to the vacuum pressure module 400 through the second vacuumizing tube 404, the sludge conveying interface 102 of the uppermost component is opened to keep the open state, and the remaining sludge conveying interface 102 is sealed by the sealing plate 105 to keep the closed state.

In the present invention, the shape of the sludge conveying interface 102 can be any shape, and its shape and size are consistent with that of the stirring cylinder 100 and the vacuum cylinder 200, so as to ensure that the sludge will not remain inside the device when treated from top to bottom.

In the specific embodiment of the present invention, with reference to FIG. 7, the sealing plate 105 includes a first sealing plate 1051 and a second sealing plate 1052, the top and bottom of the stirring cylinder, the vacuum cylinder and the standing cylinder are provided the first sealing plate 1051 and the second sealing plate 1052, the opening and closing driving member 106 includes a slide rail 1061, a first synchronous wheel 1062, a second synchronous wheel 1063, a synchronous belt 1064, a first connecting rod 1065, a second connecting rod 1066 and the opening and closing motor, the top and bottom of the stirring cylinder, the vacuum cylinder and the standing cylinder are provided with the slide rail 1061, the first sealing plate 1051 and the second sealing plate 1052 are sliding connected to the slide rail 1061, the top and bottom of the stirring cylinder, vacuum cylinder and standing cylinder are provided the first synchronous wheel 1062 and the second synchronous wheel 1063 at a certain distance interval, the first synchronous wheel 1062 and the second synchronous wheel 1063 are sleeved with synchronous belt 1064, the synchronous belt 1064 on both sides of the first synchronous wheel 1062 and the second synchronous wheel 1063 is fixed with the first connecting rod 1065 and the second connecting rod 1066 respectively, the first connecting rod 1065 and the second connecting rod 1066 are fixed with the first sealing plate 1051 and the second sealing plate 1052 respectively, and the first synchronous wheel 1062 is driven by the opening and closing motor.

In the process of use, the opening and closing motor drives the first synchronous belt 1064 to rotate, and then drives the synchronous belt 1064 to rotate, so that the first sealing plate 1051 and the second sealing plate 1052 are opened and closed. Because the slide rail 1061 limits the movement of the first sealing plate 1051 and the second sealing plate 1052 in the vertical direction, the first sealing plate 1051 and the second sealing plate 1052 are easy to open and close in the horizontal direction, and will not move vertically due to the gravity of the sludge.

Below is a detailed description of an optimization method and device based on integration of flocculation, vacuum and solidified sludge provided by the present invention by means of embodiments 1-3.

### Embodiment 1

With reference to FIG. 1, Embodiment 1 of the present invention provides an optimized method based on the integration of flocculation, vacuum, and solidified sludge for the treatment of low organic matter sludge which is represented by engineering sludge.

In the previous integrated treatment process, the interaction of various factors can produce a synergistic effect, so that the final treatment effect can reach the effect of 1+1+1>3, therefore, this integrated treatment method is widely used in engineering practice, while various factors have a synergistic effect, they often have a certain negative impact on each other, such as premature hydration products will block the drainage channel and affect the effect of vacuum preloading; premature hydration products are also detrimental to early flocculation deposition. Meanwhile, the positive impact of the previous treatment method on the latter treatment method often takes a certain amount of time to produce, for example, studies have shown that vacuum preloading immediately at the beginning of flocculation is often not as good as vacuum preloading after the supernatant produces a certain amount of water which is embodied in the final drainage volume, and the latter is often earlier than the former in the case of the same drainage amount. Therefore, the various processing steps are componentized and graded, and better processing results will be obtained compared with the previous integrated processing.

In the embodiment, firstly, through the flocculant conditioning, the sludge enters the lower vacuum component 220 of the next level when the sedimentation of the sludge in the upper vacuum component 210 does not change. The maximum effect of the flocculant is to accelerate the self-weight sedimentation of the sludge, and at the same time produce more large particles to prevent the blockage of the drainage plate by the fine particles during the vacuum preloading process. The modular grading treatment of the device can reduce the negative impact between the conditioning effects without losing the advantages of each step. When the water level in the water gas separator 403 connecting the lower vacuum component 220 does not change basically, it is put into the solidification conditioning component 130 and finally put into the standing component 310.

In the embodiment, the upper vacuum component 210 and the lower vacuum component 220 are arranged simultaneously, when the sludge sedimentation in the upper vacuum component 210 does not change, the supernatant is absorbed and then put into the lower vacuum component 220. Compared with the way of arranging the lower vacuum component 220 separately and opening the vacuum pump 401 connected by the lower vacuum component 220 after the sedimentation of the sludge in the lower vacuum component 220 is completed, the arrangement of this embodiment has the following advantages:
1. through the arrangement of this embodiment, the length of spring 232 in the vertical anti-filter tube in the lower vacuum component 220 can be reduced, and the loss of vacuum degree caused by the continuous sedimentation of the soil can be reduced;
2. when using the method of firstly standing in the lower vacuum component 220 and then opening the vacuum pump 401, the upper part of the soil will have a clear supernatant for a long time, so that the moisture content in the soil will not change for a long time, affecting the effect of vacuum preloading.

Compared with the conventional integration process, the advantages of this embodiment are as follows: this embodiment considers the time node of each conditioning step as a factor, and the various processes in the integration process are mutually reinforcing, but if the next step is carried out after the previous conditioning step is completely completed through human control, the better processing effect can often be obtained, and the total processing time will not increase too much. The device can realize automatic processing by observing the changes of the scale in the upper vacuum component 210, the lower vacuum component 220 and the water gas separator 403 through computer mechanization. Meanwhile, in the past, retarders were often used to delay the generation of hydration reactions in the integration process, but it is unknown whether cement-based retarders can promote the generation of sludge flocs, and the retarding effects of different retarders are not the same, the retarder can only play a retarding effect and cannot completely inhibit the occurrence of hydration reactions, and excessive retarders such as inorganic retarders will change the chemical products of solidification agents, which is unfavorable to strength; excessive organic retarders may also cause de-flocculation due to charge repulsion. The treatment method of this embodiment can realize the grading treatment between each conditioning step without considering the retarder by stacking each component up and down, so as to achieve a better effect than the previous integrated treatment.

Specifically, in Embodiment 1, one test example with three comparative examples was taken respectively, and the initial moisture content of the selected sludge was 500%. Test example 1 adopts the assembly method as shown in FIG. 1, and the dosage of the conditioner is 0.1% APAM and 20% cement. The comparative examples 1, 2 and 3 are a conventional integrated treatment. The difference from the present invention device is that the comparative examples 1, 2 and 3 adopt the traditional flocculation, vacuum preloading and curing integrated treatment device described in the background technology; for comparative example 1, vacuum preloading is started immediately after the stirring is completed and the device is connected, for comparative examples 2 and 3, vacuum preloading is started after the stirring is completed and stood until the liquid level does not change, the dosage of the conditioners of the comparative examples 1 and 2 is 0.1% APAM and 20% cement; the dosage of the conditioners of comparative example 3 is 0.1% APAM, 20% cement and 0.3% sodium pyrophosphate. The vacuum preloading is stopped when the vacuum preloading is carried out to the sludge height basically no longer changes.

The results are shown in Table 1.

| | Vacuum | 28 d undrained | Moisture content |
|---|---|---|---|
| | preloading | shear | after 28 d |
| | duration/h | strength/kPa | maintenance/% |
| Test example | 198 | 18.9 | 230 |
| Comparative | 406 | 13.6 | 255 |
| example 1 | | | |
| Comparative | 169 | 13.0 | 257 |
| example 2 | | | |
| Comparative | 186 | 15.8 | 238 |
| example 3 | | | |

### Embodiment 2

With reference to FIGS. 1-2, Embodiment 2 of the present invention provides an optimized method based on the integration of flocculation, vacuum, and solidified sludge based on Embodiment 1 for the treatment of high organic matter sludge represented by dredged lake mud.

The assembly methods of several components in the experimental group of Embodiment 2 from top to bottom are: flocculation conditioning component 110, upper vacuum component 210, lower vacuum component 220, oxidation conditioning component 120, solidification conditioning component 130, standing component 310; the assembly methods of several components in the control group from top to bottom are: flocculation conditioning component 110, upper vacuum component 210, lower vacuum component 220, solidification conditioning component 130, standing component 310; the variable between the two groups is whether there is an oxidant for conditioning; the sludge used is dredged lake mud with high organic matter content.

In the previous studies of integrated treatment, the variables studied were the type of conditioner, dosage and optimization of conditioning step and conditioning time. In order to reduce the research variables, studies on the engineering waste sludge with low organic matter content is often carried out; the addition of oxidant is the most simple and direct method to remove organic matter from sludge. However, humus in organic matter and flocculant APAM are both organic matters, and both of them will be unchained after being oxidized, so if the component-based grading treatment is not adopted, the oxidant and organic flocculant cannot be incorporated into the sludge simultaneously. The harm of humus is that it will adsorb on the surface of soil particles, hinder the cementation between cement hydration products and soil particles, and affect the strength after solidification; the maximum effect of flocculation in the process of integration is to separate the sludge and water and reduce the spacing between soil particles, so that the frame in the soil is easier to form; after flocculation conditioning and lower vacuum, the maximum effect of flocculation has been played in the two experimental groups, and the humus of soil particles can be disabled by the conditioning of strong oxidant, at this time, the organic matter can be removed without affecting the conditioning of flocculants for sludge soil.

In the conventional integrated treatment process, the flocculant cannot play a role when the flocculant and the oxidant are added simultaneously, the optimization method and device described in this embodiment can simultaneously achieve flocculation conditioning and oxidation conditioning in the treatment of dredged lake sludge with high organic matter content.

Specifically, the dosage of conditioner in the experimental group can be: 0.1% APAM, 0.4% potassium ferrate, and 20% cement; the dosage of conditioner in the control group can be: 0.1% APAM, 20% cement. The organic matter content of the sludge is 7.1%, and the initial moisture content is 500%.

The results are shown in Table 2.

| | 28 d undrained shear |
|---|---|
| | strength/kPa |
| Experimental | 18.4 |
| group | |
| Control group | 12.6 |

### Embodiment 3

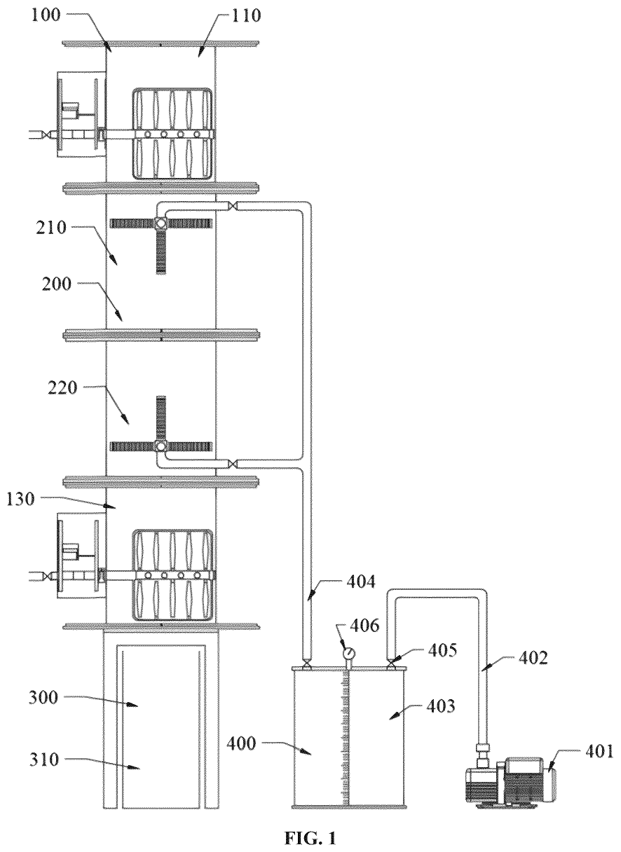

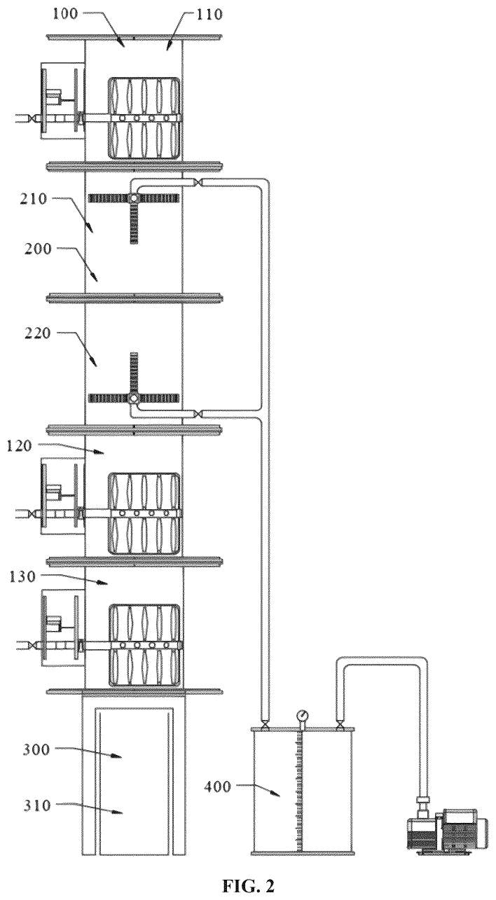

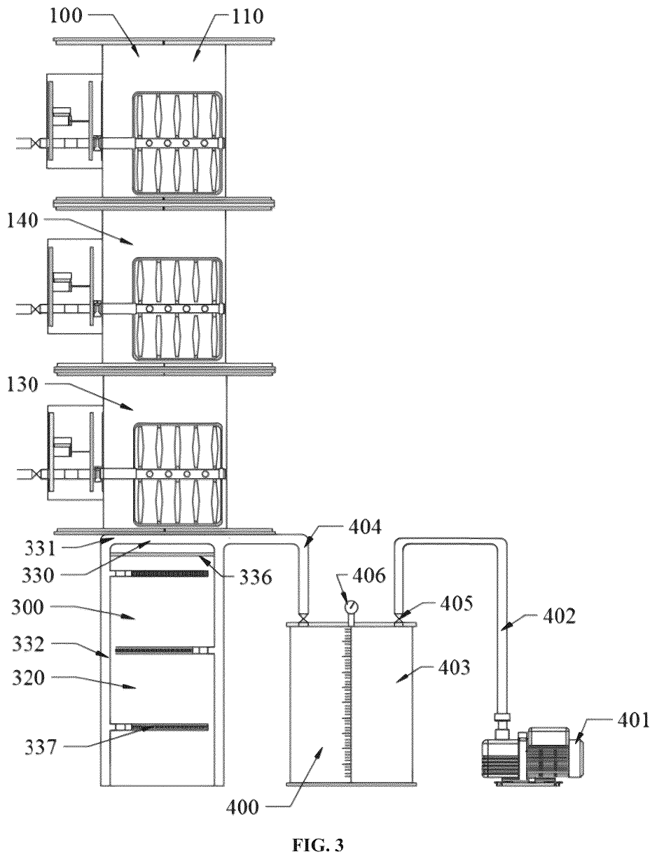

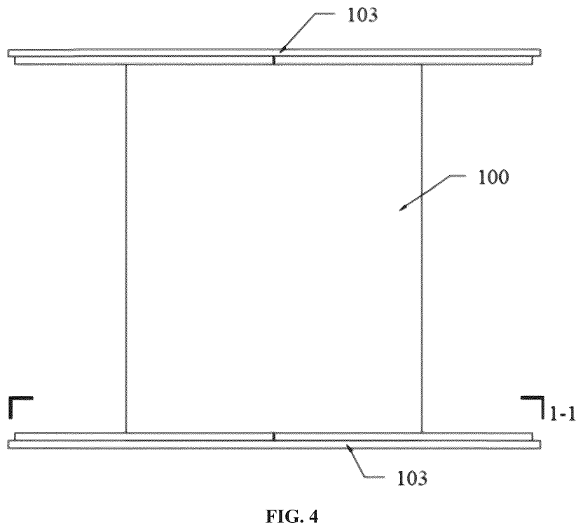

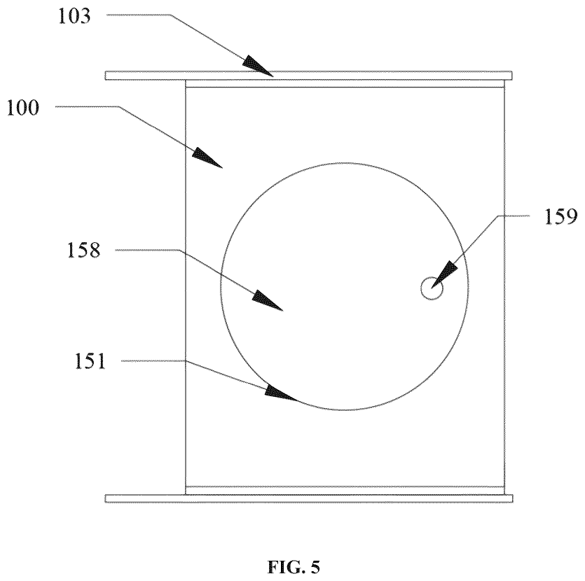

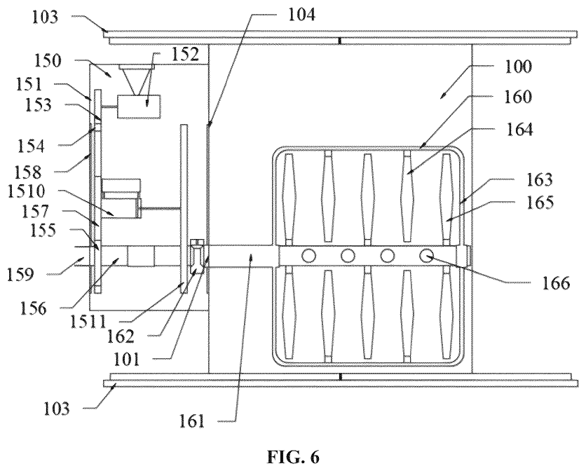

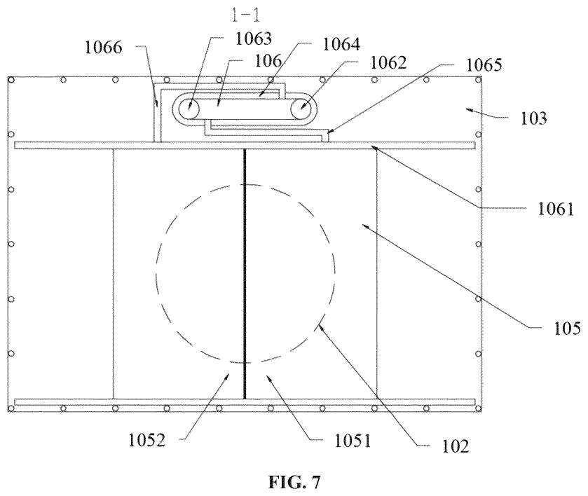

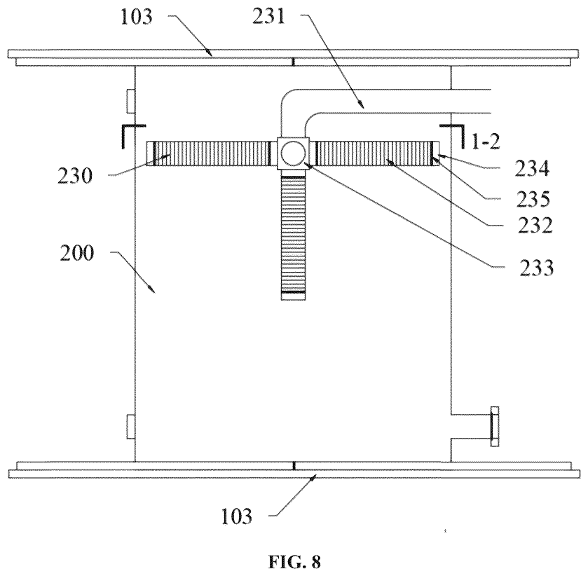

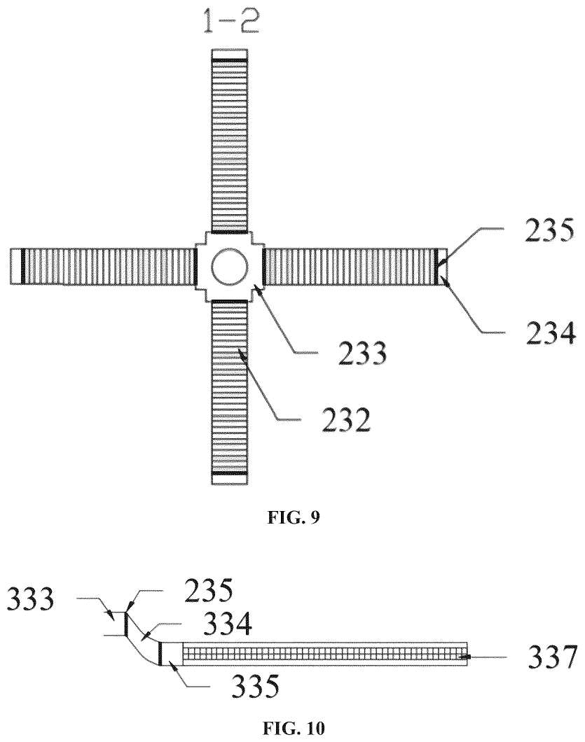

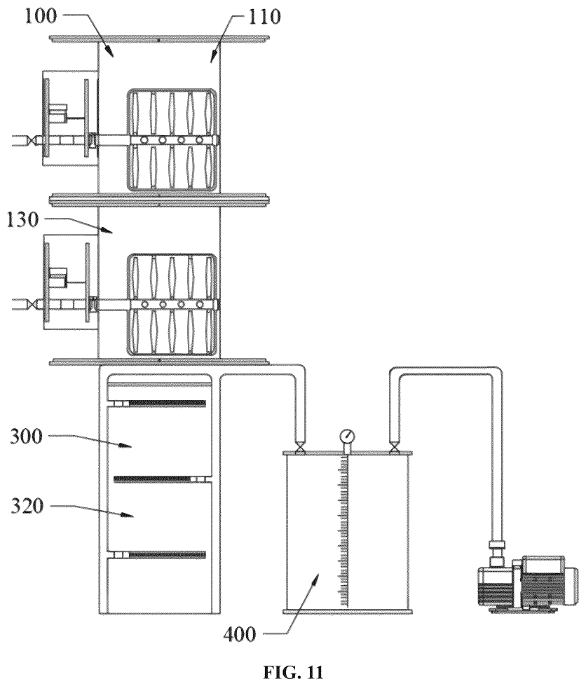

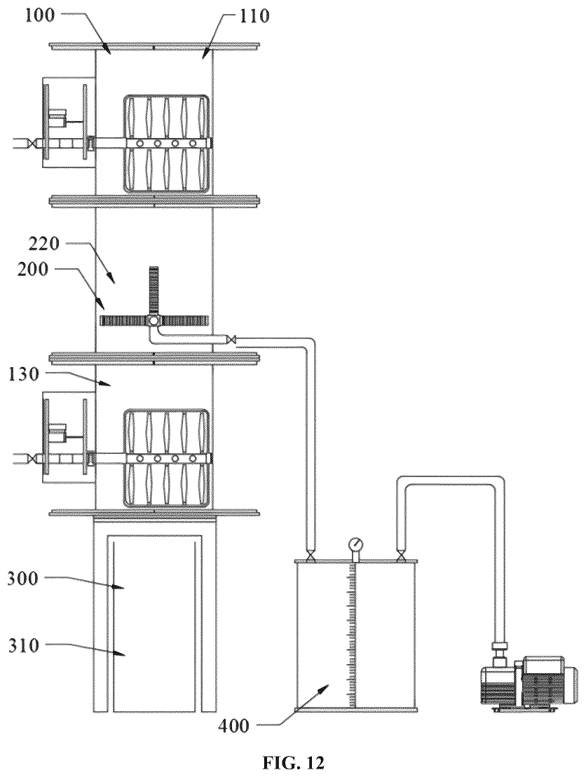

With reference to FIG. 3, FIG. 11, and FIG. 12, the embodiment of the present invention provides a method for rapid and mass treatment of engineering waste sludge.

When it is necessary to obtain a large quantity of treated sludge, for example, the foundation pit needs to quickly backfill, it takes a particularly long time for each batch of sludge to be treated by the upper vacuum component 210 and the lower vacuum component 220 by the embodiment, and at this time, it must be considered to use a retarder to delay the hydration of the solidification agent; stirring is performed by the device to obtain a plurality of groups of sludge after the stirring is completed; and the vertical vacuum tube 332 and the horizontal drainage plate 337 are laid in a plurality of standing vacuum components 320 for vacuum preloading, and the form thereof is consistent with that in a conventional manner, both are performed the vacuum preloading after the completion of stirring, and the optimization focused on the improvement of the standing vacuum process.

The assembly methods of several sludge conditioning components in the experimental group are as follows from top to bottom: as shown in FIG. 3, flocculation conditioning component 110, retardation conditioning component 140, solidification conditioning component 130, standing vacuum component 320; as shown in FIG. 11, the assembly methods of several sludge conditioning components in the first control group from top to bottom are flocculation conditioning component 110, solidification conditioning component 130, standing vacuum component 320; as shown in FIG. 12, the assembly methods of several sludge conditioning components in the second control group from top to bottom are flocculation conditioning component 110, lower vacuum component 220, solidification conditioning component 130, and standing component 310; the sludge used is engineering waste sludge with low organic matter content.

The cement generated by solidification will block the drainage channel, so that the moisture cannot be effectively drained through the vacuum preloading process; retained moisture will occupy the space where the cement forms a connection, resulting in reduced strength after solidification; the retarder can effectively delay the hydration reaction of cement, but it has little effect on the normal hydration reaction in the hydration acceleration period, so the incorporation of retarder is an indispensable conditioning agent in the realization of integrated technology.

The retarder only retards the generation of the hydration reaction, and does not affect the synergistic effect between flocculation and vacuum preloading, so there is a different mounting method in the arrangement of the second control group, that is, the second control group does not affect the coupling effect between flocculation and vacuum preloading.

By comparing the ultimate unconfined compressive strength and the shear strength of the cross plate between the experimental group and the first control group, the suitability of the effective reaction retarder in the integrated technology can be obtained; the treatment method of the second control group is a relatively ideal treatment method with a lower final moisture content and a higher final strength without considering the time factor; the final strength of the second control group was taken as the benchmark, the content and type of the retarder were changed, the final strength was determined, and the effect of the retarder was evaluated by the ratio of the strength after changed the content and type of the retarder to the final strength of the retarder, thereby selecting the most suitable type of retarder and exploring the best rapid mass treatment of engineering waste sludge.

Specifically, the initial moisture content of the selected sludge is 500%. The dosage of conditioner in experimental group 1 can be: 0.1% APAM, 0.3% sodium pyrophosphate, and 20% cement; the dosage of conditioner in experimental group 2 can be: 0.1% APAM, 0.1% sodium gluconate, 20% cement; the dosage of conditioner in the first control group can be: 0.1% APAM, 20% cement; the dosage of conditioner in the second control group can be: 0.1% APAM, 20% cement.

The results are shown in Table 3.

| | 28 d undrained shear | Relative shear |
|---|---|---|
| | strength/kPa | strength/% |
| Experimental | 15.7 | 87.2 |
| group 1 | | |
| Experimental | 17.0 | 94.4 |
| group 2 | | |
| First control | 13.6 | 75.6 |
| group | | |
| Second control | 18.0 | 100 |
| group | | |

In summary, the technical scheme of the present invention has at least the following beneficial effects:

1. the present invention provides an optimization method and device based on the integration of flocculation, vacuum and solidified sludge, the device is assembled for different treatment objects and treatment targets and targeted optimization methods are adopted, it achieves better results than conventional integrated treatment for engineering waste sludge with low organic matter content, the grading method broadens the application field of flocculation, vacuum and solidified sludge integration without affecting other steps in the case of introducing oxidant conditioning.

2. the present invention provides an optimization method and device based on integration of flocculation, vacuum and solidified sludge, which makes improvements for the whole flocculation, vacuum preloading and solidified sludge integration device. Specifically, the stirring method of the stirring link is improved, which effectively ensures the uniformity of the stirring, additionally, the vacuum link can carry out horizontal vacuum and vertical vacuum at the same time, and the horizontal vacuum of the standing link can be carried out smoothly with the sedimentation of the soil.

Finally, it should be noted that the term ‘comprise’, ‘include’ or any other variant of it is intended to cover non-exclusive inclusion, so that the process, method, item or device that includes a series of elements not only includes those elements, but also includes other elements that are not clearly listed, or also includes elements inherent to such process, method, item or device.

Although the preferred embodiments of the present invention have been described, technicians in the field can make additional changes and modifications to these embodiments once they learn the basic concept of creativity. Therefore, the attached claim is intended to be interpreted to include preferred embodiments and all changes and modifications falling within the scope of the present invention.

Obviously, technicians in this field can make various modifications and variations to the present invention without breaking away from the spirit and scope of the present invention. In this way, if these modifications and variants of the present invention belong to the scope of the present invention's claim and its equivalent technology, the present invention also intends to include these modifications and variants.

What is claimed is:

1. An optimization method based on an integration of flocculation, vacuum, and solidified sludge, comprising the following steps:
arranging a sludge treatment device, wherein the sludge treatment device comprises a flocculation conditioning component, an oxidation conditioning component, a solidification conditioning component, a retardation conditioning component, an upper vacuum component, a lower vacuum component, a standing component, and a standing vacuum component; wherein the flocculation conditioning component is added with a flocculant, the oxidation conditioning component is added with an oxidant, the solidification conditioning component is added with a solidification agent, and the retardation conditioning component is added with a retarder; the upper vacuum component, the lower vacuum component, or the standing vacuum component is evacuated through a vacuum pressure module;
determining a treatment object, comprising: dividing a sludge into a high organic matter sludge, a small batch of low organic matter sludge and a large batch of low organic matter sludge for a treatment according to an organic matter content of the sludge and a sludge quality;
treating the high organic matter sludge, comprising: performing a first top-down grading splicing on the flocculation conditioning component, the upper vacuum component, the lower vacuum component, the oxidation conditioning component, the solidification conditioning component, and the standing component;
treating the small batch of low organic matter sludge, comprising: performing a second top-down grading splicing on the flocculation conditioning component, the upper vacuum component, the lower vacuum component, the solidification conditioning component, and the standing component; and
treating the large batch of low organic matter sludge, comprising: performing a third top-down grading splicing on the flocculation conditioning component, the retardation conditioning component, the solidification conditioning component, and the standing vacuum component;
wherein in each sludge treatment process, work is completed in one component before proceeding to a next component until the treatment is completed.

2. The optimization method according to claim 1, further comprising:
in the sludge treatment process, obtaining an optimal dosage of the flocculant, the oxidant, the solidification agent, or the retarder by changing a dosage of the flocculant, the oxidant, the solidification agent, or the retarder to carry out a first plurality of tests;
obtaining an optimal time node of an action of each component by changing a time node of an action of various components to carry out a second plurality of tests; and
obtaining a comprehensive treatment effect of the flocculant, the oxidant, the solidification agent, or the retarder with different dosages and different time nodes according to a third plurality of tests.

3. The optimization method according to claim 1, wherein
the flocculant is adopted from anionic polyacrylamide, the retarder is adopted from sodium pyrophosphate or sodium gluconate, the oxidant is adopted from potassium ferrate, and the solidification agent is adopted from cement.

4. The optimization method according to claim 3, further comprising:
selecting dosages of various conditioners according to the following ratios: a ratio of a mass of the anionic polyacrylamide, a mass of the cement, and a mass of the potassium ferrate to a mass of dry soil is 0.05%-0.2%, 10%-50%, and 0.1%-0.5%, respectively, and a ratio of a mass of the sodium pyrophosphate and a mass of the sodium gluconate to the mass of the cement is 0.1%-0.6% and 0.05%-0.2%, respectively.

5. The optimization method according to claim 1, further comprising:
arranging an organic matter threshold value, wherein the organic matter threshold value is 4%-6% of a dry soil mass, and when the organic matter content exceeds the organic matter threshold value, the sludge is indicated as the high organic matter sludge, and when the organic matter content does not exceed the organic matter threshold value, the sludge is indicated as the low organic matter sludge.

6. An optimization device based on an integration of flocculation, vacuum, and solidified sludge, wherein the optimization device is configured for realizing the optimization method according to claim 1, and the optimization device comprises:
a stirring cylinder, wherein a stirrer is arranged inside the stirring cylinder, a material inlet is arranged on a side of the stirring cylinder, and the stirring cylinder is formed into the flocculation conditioning component, the oxidation conditioning component, the solidification conditioning component, or the retardation conditioning component by adding the flocculant, the oxidant, the solidification agent, or the retarder at the material inlet;
a vacuum cylinder, wherein the upper vacuum component is formed by arranging a first vacuum device in an upper part inside the vacuum cylinder, and the lower vacuum component is formed by arranging the first vacuum device in a lower part inside the vacuum cylinder;
a standing cylinder, wherein the standing component is formed when the standing cylinder is empty, and a second vacuum device is arranged inside the standing cylinder to form the standing vacuum component; and
the vacuum pressure module, wherein the vacuum pressure module comprises a vacuum pump and a water gas separator connected to the vacuum pump through a first vacuumizing tube, wherein the water gas separator is connected to the first vacuum device or the second vacuum device through a second vacuumizing tube to vacuumize the upper vacuum component, the lower vacuum component, or the standing vacuum component;
wherein the stirring cylinder, the vacuum cylinder, and the standing cylinder are all made of a transparent material, all a top and a bottom of the stirring cylinder, the vacuum cylinder, and the standing cylinder are provided with a connecting member and a sludge conveying interface, the sludge conveying interface is provided with a sealing plate and an opening and closing driving member for driving an opening and closing of the sealing plate; one or more of the flocculation conditioning component, the oxidation conditioning component, the solidification conditioning component, the retardation conditioning component, the upper vacuum component, the lower vacuum component, the standing component, and the standing vacuum component are combined according to requirements to form the sludge treatment device for treating the sludge, and adjacent components are connected through the connecting member.

7. The optimization device according to claim 6, wherein
the stirrer comprises an external driving member and an internal stirring member, the internal stirring member comprises a hollow rod and a stirring bracket connected to the hollow rod through a coaxial reverser, the stirring bracket is provided with a plurality of first stirring blades uniformly distributed at a first predetermined distance, the hollow rod is provided with a plurality of second stirring blades uniformly distributed at a second predetermined distance, the plurality of first stirring blades and the plurality of second stirring blades are alternately arranged in an extension direction of the hollow rod, the hollow rod is provided with a plurality of discharge ports, the hollow rod is fixed on the material inlet, and the external driving member drives the hollow rod to rotate.

8. The optimization device according to claim 7, wherein
the external driving member is fixed on the stirring cylinder, the external driving member comprises a drive housing, a drive motor, a drive gear, a ring gear, a planet wheel, a hollow telescopic rod, and a sun wheel, wherein the drive motor, the drive gear, the ring gear, the planet wheel, the hollow telescopic rod, and the sun wheel are arranged in the drive housing, the drive motor drives the drive gear to rotate, the drive gear meshes with an outer ring of the ring gear, an inner ring of the ring gear meshes with the planet wheel, the hollow telescopic rod is fixed on the planet wheel, the sun wheel meshes with the planet wheel, and a double-acting hydraulic pump is fixed on the sun wheel, an output shaft of the double-acting hydraulic pump is rotatably connected to a rotary member, the rotary member is fixed on the hollow telescopic rod, the drive housing is rotatably connected to a first rotary disk, a material port is arranged on the first rotary disk, a first end of the hollow telescopic rod is connected to the material port, the stirring cylinder is rotatably connected to a second rotary disk, the material inlet is arranged on the second rotary disk, and a second end of the hollow telescopic rod is connected to the material inlet.

9. The optimization device according to claim 6, wherein
the first vacuum device comprises a first horizontal vacuum tube and a plurality of springs, wherein the first horizontal vacuum tube is an L-shaped structure, a first end of the first horizontal vacuum tube is connected to the second vacuumizing tube, and a second end of the first horizontal vacuum tube is provided with a spring interface, the plurality of springs are all connected to the spring interfaces, an end of each of the plurality of springs is sleeved with a spring cover, an outside of each of the plurality of springs is wrapped with geotextile or a sealing film, and the first horizontal vacuum tube is in communication with the second vacuumizing tube.

10. The optimization device according to claim 6, wherein
the second vacuum device comprises a second horizontal vacuum tube and at least one vertical vacuum tube in communication with the second horizontal vacuum tube, the at least one vertical vacuum tube is in communication with a plurality of horizontal drainage plates with a vertical interval at a predetermined distance distribution, and the second horizontal vacuum tube is in communication with the second vacuumizing tube.

11. The optimization device according to claim 6, wherein the optimization method further comprises:
in the sludge treatment process, obtaining an optimal dosage of the flocculant, the oxidant, the solidification agent, or the retarder by changing a dosage of the flocculant, the oxidant, the solidification agent, or the retarder to carry out a first plurality of tests;
obtaining an optimal time node of an action of each component by changing a time node of an action of various components to carry out a second plurality of tests; and
obtaining a comprehensive treatment effect of the flocculant, the oxidant, the solidification agent, or the retarder with different dosages and different time nodes according to a third plurality of tests.

12. The optimization device according to claim 6, wherein in the optimization method, the flocculant is adopted from anionic polyacrylamide, the retarder is adopted from sodium pyrophosphate or sodium gluconate, the oxidant is adopted from potassium ferrate, and the solidification agent is adopted from cement.

13. The optimization device according to claim 12, wherein the optimization method further comprises:
selecting dosages of various conditioners according to the following ratios: a ratio of a mass of the anionic polyacrylamide, a mass of the cement, and a mass of the potassium ferrate to a mass of dry soil is 0.05%-0.2%, 10%-50%, and 0.1%-0.5%, respectively, and a ratio of a mass of the sodium pyrophosphate and a mass of the sodium gluconate to the mass of the cement is 0.1%-0.6% and 0.05%-0.2%, respectively.

14. The optimization device according to claim 6, wherein the optimization method further comprises:
arranging an organic matter threshold value, wherein the organic matter threshold value is 4%-6% of a dry soil mass, and when the organic matter content exceeds the organic matter threshold value, the sludge is indicated as the high organic matter sludge, and when the organic matter content does not exceed the organic matter threshold value, the sludge is indicated as the low organic matter sludge.

15. The optimization device according to claim 11, wherein
the stirrer comprises an external driving member and an internal stirring member, the internal stirring member comprises a hollow rod and a stirring bracket connected to the hollow rod through a coaxial reverser, the stirring bracket is provided with a plurality of first stirring blades uniformly distributed at a first predetermined distance, the hollow rod is provided with a plurality of second stirring blades uniformly distributed at a second predetermined distance, the plurality of first stirring blades and the plurality of second stirring blades are alternately arranged in an extension direction of the hollow rod, the hollow rod is provided with a plurality of discharge ports, the hollow rod is fixed on the material inlet, and the external driving member drives the hollow rod to rotate.

16. The optimization device according to claim 12, wherein
the stirrer comprises an external driving member and an internal stirring member, the internal stirring member comprises a hollow rod and a stirring bracket connected to the hollow rod through a coaxial reverser, the stirring bracket is provided with a plurality of first stirring blades uniformly distributed at a first predetermined distance, the hollow rod is provided with a plurality of second stirring blades uniformly distributed at a second predetermined distance, the plurality of first stirring blades and the plurality of second stirring blades are alternately arranged in an extension direction of the hollow rod, the hollow rod is provided with a plurality of discharge ports, the hollow rod is fixed on the material inlet, and the external driving member drives the hollow rod to rotate.

17. The optimization device according to claim 13, wherein
the stirrer comprises an external driving member and an internal stirring member, the internal stirring member comprises a hollow rod and a stirring bracket connected to the hollow rod through a coaxial reverser, the stirring bracket is provided with a plurality of first stirring blades uniformly distributed at a first predetermined distance, the hollow rod is provided with a plurality of second stirring blades uniformly distributed at a second predetermined distance, the plurality of first stirring blades and the plurality of second stirring blades are alternately arranged in an extension direction of the hollow rod, the hollow rod is provided with a plurality of discharge ports, the hollow rod is fixed on the material inlet, and the external driving member drives the hollow rod to rotate.

18. The optimization device according to claim 14, wherein
the stirrer comprises an external driving member and an internal stirring member, the internal stirring member comprises a hollow rod and a stirring bracket connected to the hollow rod through a coaxial reverser, the stirring bracket is provided with a plurality of first stirring blades uniformly distributed at a first predetermined distance, the hollow rod is provided with a plurality of second stirring blades uniformly distributed at a second predetermined distance, the plurality of first stirring blades and the plurality of second stirring blades are alternately arranged in an extension direction of the hollow rod, the hollow rod is provided with a plurality of discharge ports, the hollow rod is fixed on the material inlet, and the external driving member drives the hollow rod to rotate.

19. The optimization device according to claim 15, wherein
the external driving member is fixed on the stirring cylinder, the external driving member comprises a drive housing, a drive motor, a drive gear, a ring gear, a planet wheel, a hollow telescopic rod, and a sun wheel, wherein the drive motor, the drive gear, the ring gear, the planet wheel, the hollow telescopic rod, and the sun wheel are arranged in the drive housing, the drive motor drives the drive gear to rotate, the drive gear meshes with an outer ring of the ring gear, an inner ring of the ring gear meshes with the planet wheel, the hollow telescopic rod is fixed on the planet wheel, the sun wheel meshes with the planet wheel, and a double-acting hydraulic pump is fixed on the sun wheel, an output shaft of the double-acting hydraulic pump is rotatably connected to a rotary member, the rotary member is fixed on the hollow telescopic rod, the drive housing is rotatably connected to a first rotary disk, a material port is arranged on the first rotary disk, a first end of the hollow telescopic rod is connected to the material port, the stirring cylinder is rotatably connected to a second rotary disk, the material inlet is arranged on the second rotary disk, and a second end of the hollow telescopic rod is connected to the material inlet.

20. The optimization device according to claim 16, wherein
the external driving member is fixed on the stirring cylinder, the external driving member comprises a drive housing, a drive motor, a drive gear, a ring gear, a planet wheel, a hollow telescopic rod, and a sun wheel, wherein the drive motor, the drive gear, the ring gear, the planet wheel, the hollow telescopic rod, and the sun wheel are arranged in the drive housing, the drive motor drives the drive gear to rotate, the drive gear meshes with an outer ring of the ring gear, an inner ring of the ring gear meshes with the planet wheel, the hollow telescopic rod is fixed on the planet wheel, the sun wheel meshes with the planet wheel, and a double-acting hydraulic pump is fixed on the sun wheel, an output shaft of the double-acting hydraulic pump is rotatably connected to a rotary member, the rotary member is fixed on the hollow telescopic rod, the drive housing is rotatably connected to a first rotary disk, a material port is arranged on the first rotary disk, a first end of the hollow telescopic rod is connected to the material port, the stirring cylinder is rotatably connected to a second rotary disk, the material inlet is arranged on the second rotary disk, and a second end of the hollow telescopic rod is connected to the material inlet.
